(19) United States
(12) Patent Application Publication
(10) Pub. No.: US 2016/0310958 A1
(43) Pub. Date: Oct. 27, 2016

(54) REMOTE CONTROLLED GARBAGE DISPOSAL SYSTEM

(71) Applicant: Jacov Marom, Laguna Woods, CA (US)

(72) Inventor: Jacov Marom, Laguna Woods, CA (US)

(21) Appl. No.: 14/696,428

(22) Filed: Apr. 25, 2015

(51) Int. Cl. B02C 25/00; H01H 21/26; E03C 1/266

(52) U.S. Cl. CPC B02C 25/00; E03C 1/2665; H01H 21/26

(57) ABSTRACT

A method and system for remotely switching a kitchen garbage disposal on or off in an area where there's risk of electrical shock due to the presence of water associated with a kitchen's countertop is disclosed. The method is accomplished by installing an electrically actuated foot pedal switch within the existing electrical circuit which powers the kitchen garbage disposal. The electrically actuated foot pedal switch is moveable between an on and an off position. In the on or pressed down position, electrical current is supplied thereby supplying power to the kitchen garbage disposal. When the electrically actuated foot pedal switch is released it moves up to the off position wherein electrical current is cut off to the kitchen garbage disposal. The supply current is provided by use of an electrical cord, wirelessly or by voice activation from the actuated foot pedal switch to the kitchen garbage disposals electrical power input.

### FIELD OF THE INVENTION

This invention relates to kitchen garbage disposals and more particularly to a method for remotely switching the kitchen garbage disposal on and off in order to prevent a risk of electrical shock due to the presence of water associated with the kitchen area.

### BACKGROUND OF THE INVENTION

Prior art methods of operating kitchen garbage disposals which are permanently mounted under a kitchen sink include providing the garbage disposal with a nearby wall mounted electrical switch for switching the kitchen garbage disposal on and off. The electrical switch is operated by means of a person grasping and moving a protruding toggle of the switch which protrudes above a switch wall plate so that an electrical connection of the circuit powering the kitchen garbage disposal is made or broken as a direct result of the person moving the switch between an on and off position. Live electrical wires which supply power to the kitchen garbage disposal are usually no more than about a half inch from that portion of the switch which the user grasps or touches. This presents an electrical hazard when the wall mounted switch is located adjacent to wet areas, such as the kitchen countertop, where the switch may be splashed with water, or where the user is likely to have wet hands.

Because contacting the switch with water presents an electrical hazard, it may not be safe to wipe down a dirty switch with a wet cloth or other cleaning implement. A need exists, therefore, for an improved method for switching a kitchen garbage disposal on and off where there is a risk of electrical shock due to the presence of water in the surrounding environment. A need also exists for a kitchen garbage disposal system which may be easily installed within the existing electrical circuitry of a conventional kitchen, without requiring customization of the existing kitchen garbage disposal being retrofitted, or the existing associated kitchen electrical switch. Therefore, what is needed is a remote controlled kitchen garbage disposal system that solves this and others problems in a novel and unique manner.

### SUMMARY OF THE INVENTION

The present invention provides a method and system for switching a kitchen garbage disposal on or off in an area where there is a risk of electrical shock due to the presence of water associated with a kitchen's countertop. The method is accomplished by installing an electrically actuated foot pedal switch within the existing electrical circuit which powers the kitchen garbage disposal. The electrically actuated foot pedal switch is moveable between an on and an off position. In the on position or when pressed down, electrical current is supplied thereby supplying power to the kitchen garbage disposal. When the electrically actuated foot pedal switch is released it moves up to the off position wherein electrical current is cut off to kitchen garbage disposal. The supply current is provided by use of an electrical cord, wirelessly or by voice activation from the actuated foot pedal switch to the electrical power input within the electrical circuit of the kitchen garbage disposal.

### DESCRIPTION OF THE DRAWINGS

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention. In the accompanying drawings:

FIG. 1 shows a prior art kitchen having a garbage disposal unit with a conventional wall mounted electrical switch used to operate the garbage disposal unit;

FIG. 2 is a block diagram illustrating one preferred embodiment for a remote controlled garbage disposal system in accordance with the present invention;

FIG. 3 is a block diagram illustrating another preferred embodiment for a wireless remote controlled garbage disposal system in accordance with the present invention; and

FIG. 4 is a perspective view of a speech activated device for use with the remote controlled garbage disposal system shown in FIG. 3.

### DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention

Reference will now be made in detail to embodiments, methods and systems of the present invention known to the inventor. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

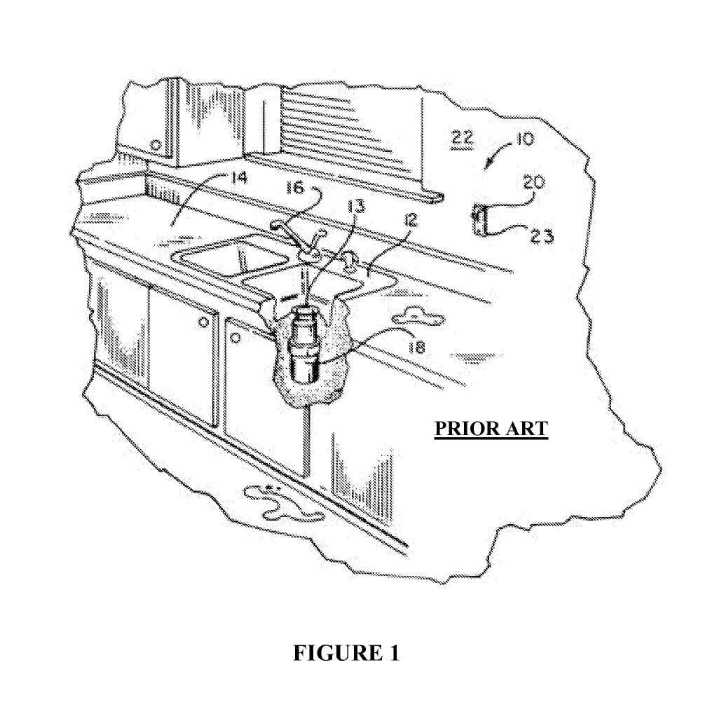

Referring now to FIG. 1 there is shown a typical prior art kitchen environment 10 which is provided with a sink 12 mounted within a counter space 14. The sink 12 is provided with a faucet 16 of conventional design connected to a conventional water supply (not shown), the sink also being provided with a drain 13 for draining the contents of the sink 12. A garbage disposal unit 18 is mounted under the sink 12 for grinding waste material that is passed out of the sink 12 through the drain 13. The garbage disposal unit 18 is operated by means of a conventional single pole, single throw electrical switch 20 mounted within a wall box of the kitchen vertical wall 22. The switch internal components which are housed within the wall box are covered by a wall plate 23.

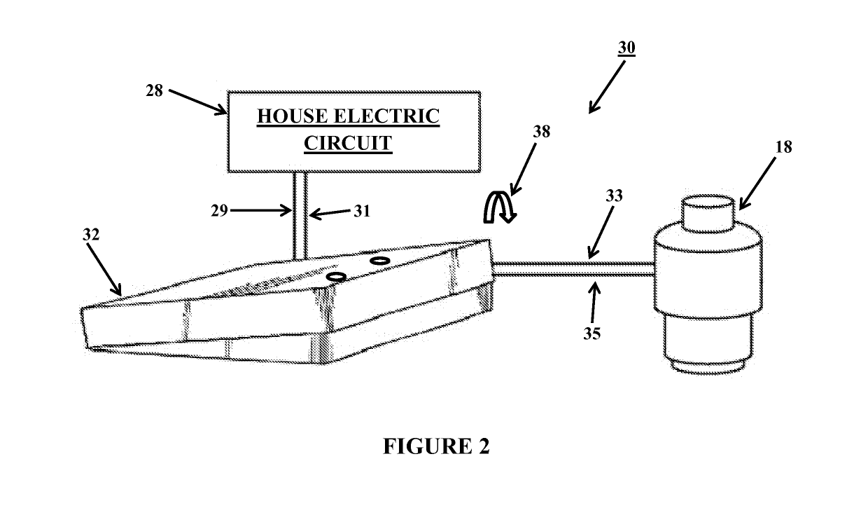

Referring now to FIG. 2, there is shown one preferred embodiment for a remote controlled garbage disposal system 30 in accordance with the present invention. The kitchen garbage disposal 18 is powered by means of a house or dwelling electrical circuit 28. The method of the present invention is accomplished by installing an electrically actuated foot pedal switch 32 within the existing electrical circuit 28 which powers the kitchen garbage disposal 18. Electrically actuated foot pedal switches 32 are known in the art and are commercially available. Referring once again to FIG. 2, a pair of electrical leads 29, 31 are connected by means of suitable wiring within the house electrical circuit 28 to the electrically actuated foot pedal switch 32 wherein a pair of electrical leads 33, 35 are connected by means of suitable wiring within the electrically actuated foot pedal switch 32 to the kitchen garbage disposal 18 thereby completing an electrical system for powering the kitchen garbage disposal 18.

The electrically actuated foot pedal switch 32, in this case a two position switch 26, is also is installed and connected to the electrical circuit 28 thereby replacing the conventional electrical switch, shown as 20 in FIG. 1. Alternatively, the electrically actuated foot pedal switch 32 can be installed with the electrical circuit 28 such that the conventional electrical switch (20 in FIG. 1) may also be used. The conventional switch 20 then becomes a fail-safe switch for the circuit. That is, it can be left on continually with the electrically actuated foot pedal switch 32 being used to control the garbage disposal 18, or can be switched to the off position to disable the circuit. In use, the electrically actuated foot pedal switch 18 is moveable between an on and an off position 38. In the on position or when pressed down, electrical current is supplied thereby supplying power to the kitchen garbage disposal 18. When the electrically actuated foot pedal switch 32 is released it moves up to the off position wherein electrical current is cut off to kitchen garbage disposal 18. The supply current is provided by use of electrical cords having leads 29, 31, 33 and 35, respectively, from electrical circuit 28 to actuated foot pedal switch 32 to the electrical power input within the electrical circuit of the kitchen garbage disposal 18.

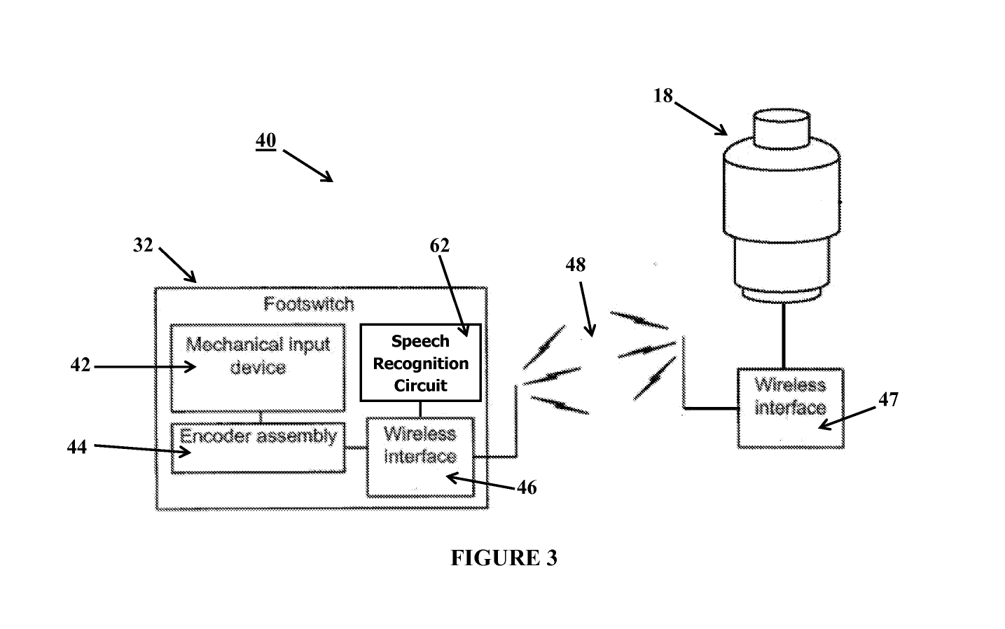

Referring now to FIG. 3, there is shown a functional block diagram illustrating another preferred embodiment for a wireless remote controlled garbage disposal system 40 in accordance with the present invention. The actuated foot pedal switch 28 contains a mechanical input device such as pedal 42 that couples to encoder assembly 44 in order to produce a control signal that is provided to wireless interface 46. Wireless interface 46 is operable to establish a wireless communication pathway 48 between actuated foot pedal switch 28 and kitchen garbage disposal 18. More specifically, wireless interface 46 communicatively couples to wireless interface 47 of the kitchen garbage disposal 18. Thus, the control signal(s) produced by encoder assembly 44 are able to be communicated to kitchen garbage disposal 18 via the wireless pathway 48. The kitchen garbage disposal 18 is now operable by the actuated foot pedal switch 28 based on the control signal(s) that are wirelessly relayed from switch 28 to disposal 18.

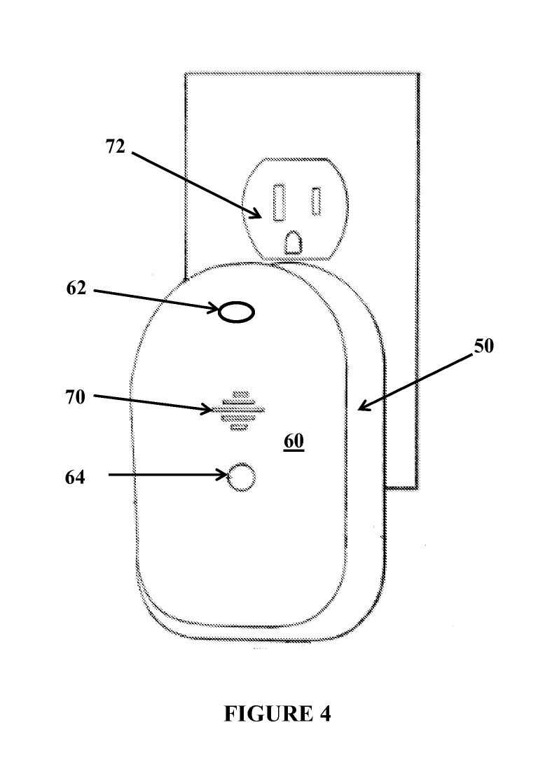

Referring now to FIG. 4, there is shown a perspective view of a speech activated device 50 for use with the electrically actuated foot pedal switch 32 to remotely control the garbage disposal 18. The device consists of a shell 60 that houses speech recognition circuitry (not shown) for communicating with speech recognition circuitry 62 housed within the electrically actuated foot pedal switch 32 as shown in FIG. 3. The speech activated device 50 is designed to be compact and self-contained such that the entire device 50 plugs into a utility outlet 72. The shell 60 contains several openings for components of a speech recognition circuit, and may include openings for an indicating device 64, a speaker 70, a microphone 62 and a standard AC utility plug (not shown) which plugs into the utility outlet 72. In use, the user verbally issues on and off commands to control the operation of the kitchen garbage disposal 18 in lieu of pressing the actuated foot pedal switch 28 up and down with their foot.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

moving said electrically actuated foot pedal switch between an on and an off position, wherein in the on or pressed down position, electrical current is supplied thereby supplying power to the kitchen garbage disposal. and when said electrically actuated foot pedal switch is released it moves up to the off position wherein electrical current is cut off to the kitchen garbage disposal. The supply current is provided by use of an electrical cord, wirelessly or by voice activation from the actuated foot pedal switch to the kitchen garbage disposals electrical power input.

What is claimed is:

1. A method for remotely switching a kitchen garbage disposal on or off in an area where there's risk of electrical shock due to the presence of water associated with a kitchen's countertop, the method comprising:
installing an electrically actuated foot pedal switch within the existing electrical circuit which powers the kitchen garbage disposal, wherein said electrically actuated foot pedal switch being movable between an on position, where electrical current is supplied to the kitchen garbage disposal thereby powering kitchen garbage disposal, and an off position, where electrical current is cut off from kitchen garbage disposal.

2. The method according to claim 1 further comprising the step of moving said electrically actuated foot pedal switch to an on position when said switch is pressed in a down position, wherein electrical current is supplied thereby supplying power to the kitchen garbage disposal.

3. The method according to claim 1 further comprising the step of moving said electrically actuated foot pedal switch to an off position when said switch is released in an up position, wherein electrical current is cut off from supplying power to the kitchen garbage disposal.

4. The method according to claim 1 further comprising the step of remotely controlling power to the kitchen garbage disposal by using a wireless interface housed within said electrically actuated foot pedal switch and activated by use of said pedal switch for wirelessly communicating to a wireless interface attached to the garbage disposal for powering on and off the garbage disposal.

5. The method according to claim 1 further comprising the step of remotely controlling power to the kitchen garbage disposal by using a voice recognition circuit installed to the kitchen wall outlet for communication to a voice recognition circuit electrically to a wireless interface both housed within said electrically actuated foot pedal switch for wirelessly communicating to a wireless interface attached to the garbage disposal for powering on and off the garbage disposal using a user's voice commands.
